(19) United States
(12) Patent Application Publication
(10) Pub. No.: US 2025/0366445 A1
(43) Pub. Date: Dec. 4, 2025

(54) Method for Forming Oyster Reefs

(71) Applicant: THE ZIP PROJECT LLC, Tallahassee, FL (US)

(72) Inventors: Katherine E. Stewart, Tallahassee, FL (US); Mike Keramidas, Tallahassee, FL (US)

(21) Appl. No.: 18/976,424

(22) Filed: Dec. 11, 2024

Related U.S. Application Data
(63) Continuation-in-part of application No. 18/677,938, filed on May 30, 2024.

(51) Int. Cl. A01K 61/54

(52) U.S. Cl. CPC A01K 61/54

(57) ABSTRACT

Disclosed is a device and an associated method for promoting the formation of oyster reefs. The device includes a number of interconnected wire enclosures. The wire enclosures house non-living oyster shells. These oyster shells attract oyster larvae and promote reef formations. The enclosures are preferably interconnected to form a closed pen with the bottom of the pen formed by a biodegradable mesh netting. Additional non-living oyster shells can be positioned over top of the netting. The wire enclosures serve to protect larvae that attaches to the oyster shells. This, in turn, ensures that oyster reef formations are promoted.

### CROSS-REFERENCE TO RELATED APPLICATION

This is a continuation-in-part of application Ser. No. 18/677,938, filed May 30, 2024, which is incorporated by reference herein in its entirety.

### TECHNICAL FIELD

This disclosure relates to an apparatus and method for forming oyster reefs. More specifically, the disclosure relates to an apparatus and an associated method for storing and submerging oyster shells as a means for attracting, growing, and protecting oyster larvae and promoting the growth of oyster reefs.

### BACKGROUND OF THE INVENTION

Oyster reefs are large conglomerations of oysters that exist within coastal water ways. Oyster reefs are sometimes referred to as oyster beds, oyster banks, or oyster bottoms. Oyster reefs are formed when oyster larvae attach to and grow upon submerged marine formations, such as concrete slabs or rocky areas. Oyster larvae can also attach to the shells of other living and non-living oysters. Over time, the attached larvae mature into full grown oysters and form large oyster reefs. Oyster reefs are beneficial to both coastal regions and surrounding marine life and form an essential part of underwater ecosystems. However, due to coastal degradation, overharvesting, and human development, oyster reefs have seen significant declines around the world. These declines have, in turn, negatively impacted coastal water ways and the surrounding marine life. In view of this, efforts have been made over the years to foster the growth of oyster reefs.

For example, U.S. Pat. No. 5,269,254 to Gagliano et al. discloses a method and apparatus for growing an oyster reef. The apparatus of Gagliano includes a cultch material that contains seed oysters. These seed oysters are positioned on vertically arranged and water permeable panels. Water with conditions favorable to oyster growth is then permitted to flow through the vertically arranged panels. Furthermore, U.S. Pat. Pub. 2016/0212978 to Matthews, Ill et al. discloses a shellfish trap system for developing a reef. The trap system includes a growing assembly having first and second protective layers. The first protective layer is removed from the trap system after the completion of a first developmental stage. The growing assembly includes a material that is conducive for shellfish in the pediveliger larvae stage to attach to.

Although the background art achieves certain notable objectives, all of the background art suffers from certain drawbacks. Namely, the background art does not provide a device that is economical, environmentally friendly, easy to deploy, and that effectively promotes reef formation. The apparatus and method of the present disclosure successfully overcome these and other drawbacks present in the background art.

### SUMMARY OF THE INVENTION

This disclosure relates to an apparatus for forming oyster reefs that is economical, environmentally friendly, and easy to deploy.

The disclosed apparatus has several important advantages. For example, the device uses oyster shells to attract oyster larvae and promote reef formation.

A further possible advantage is achieved by housing the oyster shells in one or more wire cages, with the cages serving to protect the larvae from marine life and ocean tides.

Still yet another possible advantage is attained by interconnecting several wire cages to form a pen, with the pen being used to store additional oyster shells.

Another advantage of the apparatus and method is realized by providing a series of interconnected wire cages, with a bottom formed from a biodegradable mesh netting.

These and other advantages are provided by an apparatus for forming oyster reefs, including a series of wire cages, with each wire cage having an interior area, the interior area of each wire cage being filled with oyster shells. The series of wire cages are secured together to form a closed pen. A mesh netting is secured to the series of wire cages to form a floor of the pen. Additional oyster shells can be supplied over top of the floor.

Various embodiments of the invention may have none, some, or all of these advantages. Other technical advantages of the present invention will be readily apparent to one skilled in the art.

### BRIEF DESCRIPTION OF THE DRAWINGS

For a more complete understanding of the present disclosure and its advantages, reference is now made to the following descriptions, taken in conjunction with the accompanying drawings, in which:

FIG. 1 is a perspective view of the apparatus for forming oyster reefs.

FIG. 2 is a perspective view of the device of FIG. 1 with the wire cages and pen filled with oyster shells.

FIG. 3 is a perspective view of the apparatus as submerged within a body of water.

FIG. 4 is a perspective view of an alternative embodiment of the apparatus for forming oyster reefs.

FIG. 5 is a perspective view of the alternative embodiment shown filled with oyster shells.

FIG. 6 is a perspective view of the alternative embodiment submerged within a body of water.

FIG. 7 is a further embodiment illustrating a series of four cages tied together to form a larger apparatus for forming oyster reefs.

FIG. 8 is a perspective view of another embodiment of the apparatus for forming oyster reefs.

FIG. 9 is a perspective view of the embodiment of the apparatus shown filled with oyster shells.

FIG. 10 is a perspective view of the embodiment of the apparatus shown attached to a dock.

The various reference numerals refer to similar parts throughout the several views of the drawings.

### DETAILED DESCRIPTION OF THE DRAWINGS

The present disclosure relates to an apparatus and an associated method for promoting the formation of oyster reefs within coastal water ways. The apparatus includes a number of interconnected wire enclosures for housing oyster shells. These oyster shells attract oyster larvae and promote the growth of larger reef formations. In one embodiment of the invention, the wire enclosures are interconnected in an end-to-end fashion to form a closed pen. The floor of the pen is provided via a mesh netting. A biodegradable netting is preferred. Additional oyster shells can be positioned upon the floor of the pen. The various oyster shells, both within the wire enclosures and upon the floor, serve as surfaces to attract oyster larvae and allow them to mature into full grown oysters. The wire enclosures protect the larvae from marine life and ocean currents. This, in turn, ensures that oyster reef formations are promoted.

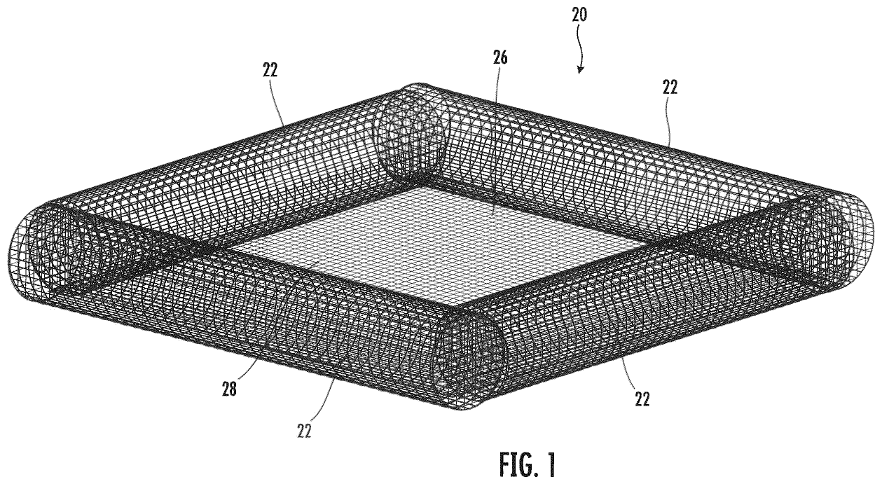

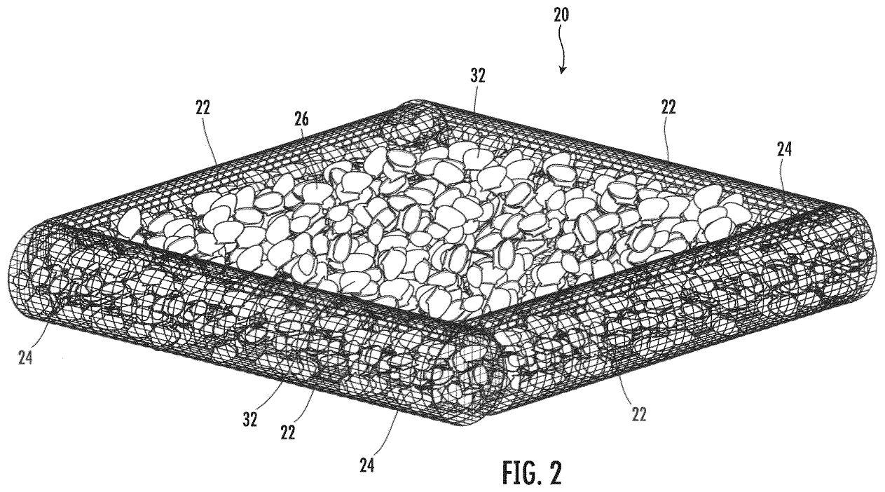

With reference to FIG. 1, the apparatus (20) for promoting reef formation is depicted. Device (20) is shown without any shells being positioned upon or within device (20). Device (20) is ultimately adapted to be completely or partially submerged under water where it interacts with marine life and ocean currents. In the illustrated embodiment, device (20) is formed from four, cylindrically shaped wire cages (22). Cages (22) can be made, for example, from welded wire. The wire can be of various gauges. After cylindrical cages (22) are formed, the ends of each cage (22) are preferably closed off with additional segments of wire mesh. The result is a completely enclosed cage (22) within a hollow interior area. Prior to the ends being closed, cages (22) can be filled with oyster shells. In a non-limiting example, each wire cage (22) is approximately 4.5 feet long, 6 inches high, and houses approximately 5 gallons of non-living oyster shells (24) (FIG. 2). These dimensions are provided for illustrative purposes and the use cages having other shapes, sizes, and configurations, and made from other materials is within the scope of the present disclosure.

As illustrated in FIGS. 1-2, the four cylindrical wire cages (22) are secured in an end-to-end fashion to form a larger rectangular pen (26). The individual wire cages (22) can be joined by lashing together adjacent ends within tie-wire and plyers. Other means of joining the ends will be readily apparent to those of ordinary skill in the art. Once the ends are secured together, a mesh netting (28) is secured to the bottom of each cage (22). Again, mesh netting (28) can be secured to the cages (22) via tie-wire or similar type fasteners. Regardless of how it is secured, mesh netting (28) is sufficient to form a lower floor of the pen (26). In the depicted embodiment, given that each cage (22) is approximately 4.5 feet long, once assembled, the overall apparatus (20) is approximately 4.5 feet long, 5.5 feet wide. This makes mesh netting (28) large enough to support approximately 10 gallons of oyster shells (32). It is preferable that the shells (32) supported upon netting (28) do not extend to a height that is higher that the height of the surrounding wire cages (22).

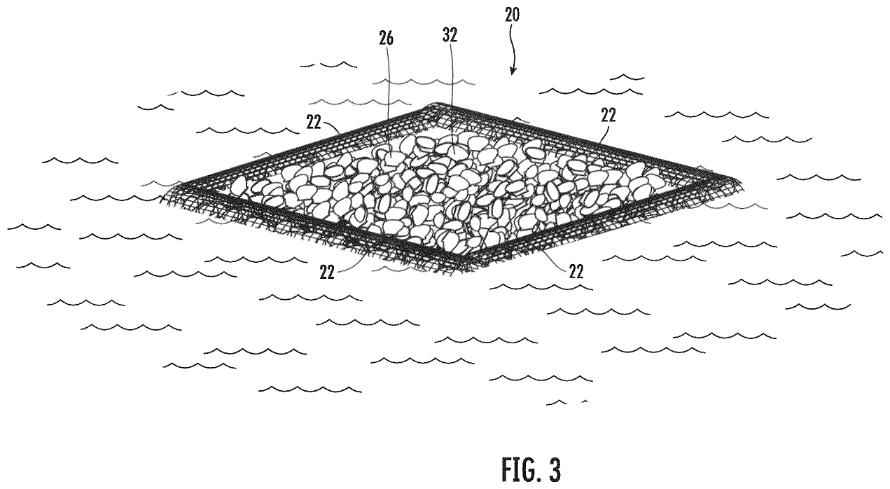

In use, the individual cages (22) are formed and filled with non-living oyster shells (24) and thereafter their ends are closed with additional wire. The ends of the cages (22) are then secured together. Mesh netting (28) is thereafter used to form a floor between the various cages (22). Next, additional oyster shells (32) are added over top of the netting (28). Thereafter, as illustrated in FIG. 3, the entire assembled apparatus (20) is submerged. Once under water, oyster shells (24) are protected via wire cages (22). Oyster shells (34) within the pen (26) are also protected by the height of the surrounding cages (22). Over time, oyster larvae attach to the shells (24, 32), both within cages (22) and upon netting (28), and an oyster reef is built up. In this manner, apparatus (20) protects the growing oyster larvae from both marine life and any ocean currents.

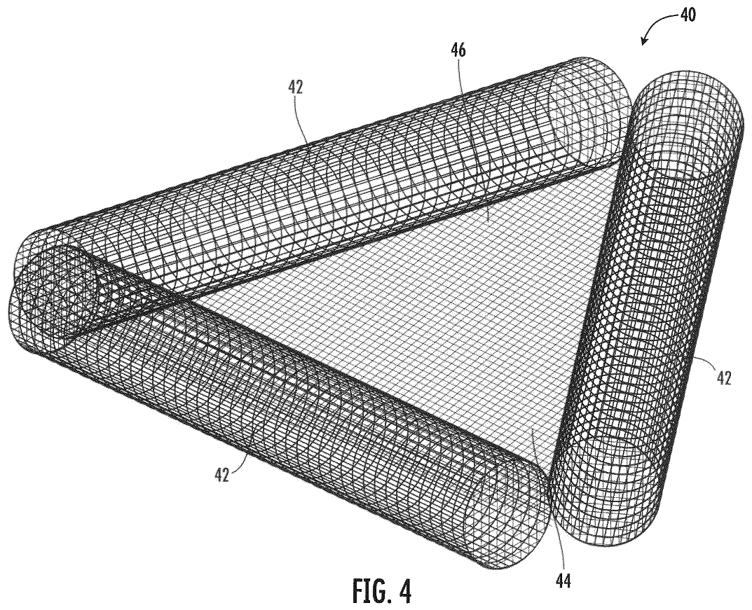

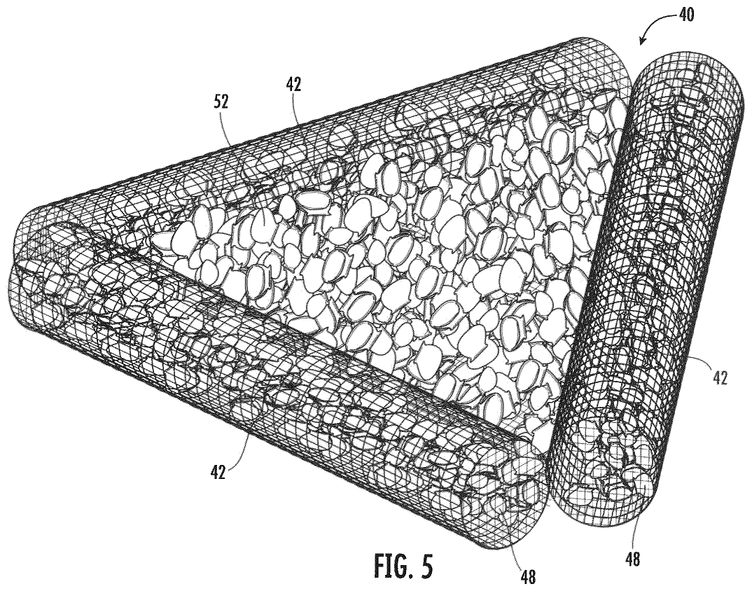

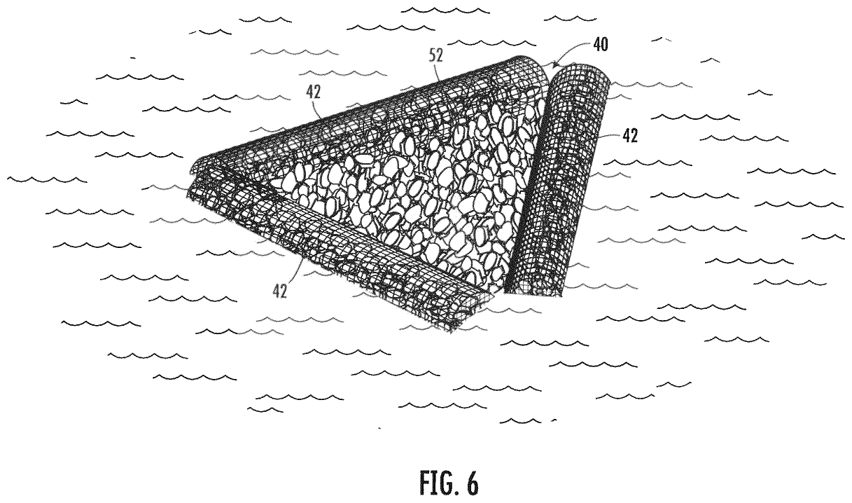

An alternative embodiment of the present disclosure is illustrated in FIGS. 4-6. This embodiment is the same in most respects to the embodiment of FIGS. 1-3. However, FIGS. 4-6 illustrate an apparatus (40) that is formed from three cylindrical cages (42) that are secured together to form a triangular pen (44). A layer of mesh netting (46) is provided at the bottom of pen (44). Cages (42) are filled with oyster shells (48) and additional oyster shells (52) are provided over top of netting (46). As illustrated in FIG. 6, the entire apparatus (40) is then submerged to promote oyster reef formation.

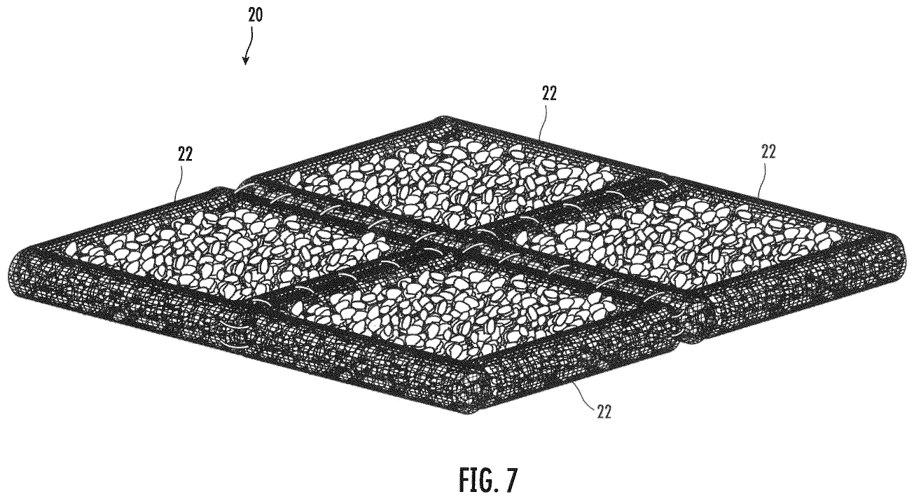

FIG. 7 illustrates another embodiment of the present disclosure. As illustrated a series of four wire cages (22) are connected to one another to form a larger apparatus (20). The individual cages (22) can be connected along their respective edges via zip ties or similar fasteners. Any number of cages (22) can be fitted together in a variety of configurations to provide a sufficiently large oyster reef.

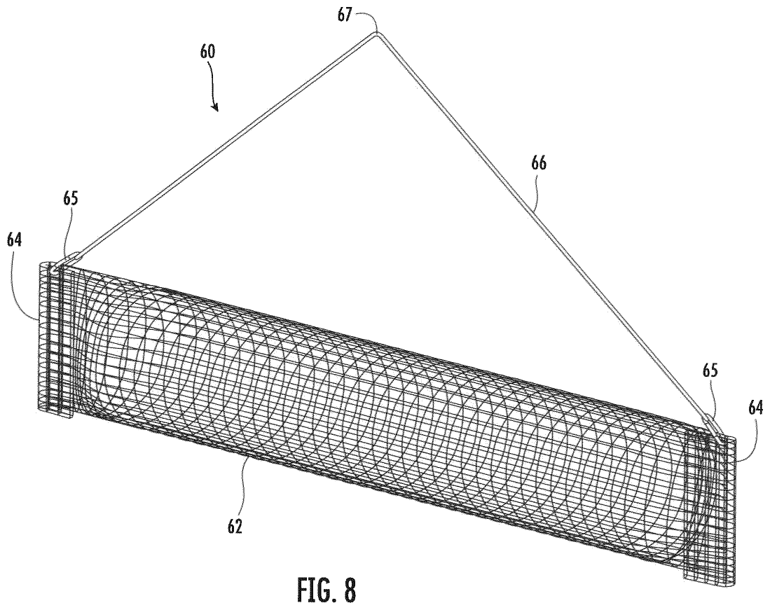

FIG. 8 illustrates another embodiment of the present disclosure. In the example shown, the apparatus (60) includes a wire cage (62), end caps (64), a mounting wire (66), and attachment members (65). The wire cage (62) is a rectangular piece of wire mesh that is rolled into a cylindrical shape that defines a cylindrical volume. The cylindrical volume of the wire cage (62) is large enough to house five to ten gallons of non-living oysters. The wire cage (62) may also be other shapes, such as a rectangular prism, a triangular prism, or the like. The wire cage (62) may include one or more open ends and one or more closed ends. In the example shown, the wire cage (62) has two open ends. The ends of the wire cage (62) are tapered to a substantially planar edge. The end caps (64) are rectangular pieces of wire mesh that are folded to be substantially planar, around the ends of the wire cage (62). The end caps (64), however, may also be other shapes and may not be folded, and they may be affixed to the ends of the wire cage (62) in other ways, such as by staples, zip ties, tie-wire, a hinge and latch, or the like. The mounting wire (66) is affixed to the wire cage (62) and the end caps (64) via attachment members (65). The attachment members (65) are loops of wire, but they may also be hooks, clamps, clips, or the like. Alternatively, the mounting wire (66) may be affixed directly to the wire cage (62) and/or the end caps (64), such as by tying or bending it. Respective ends of the mounting wire (66) are attached to respective ends of the wire cage (62). The mounting wire (66) may alternatively be affixed only to the wire cage (62) or only to the end caps (64).

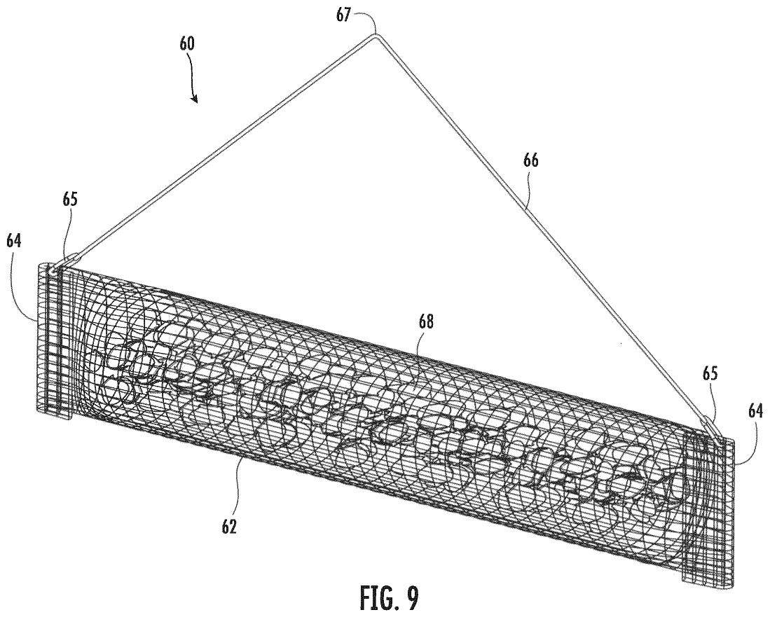

Referring to FIG. 9, the example shown in FIG. 8 is now shown filled with oyster shells (68). The oyster shells (68) may be inserted into the volume defined by the wire cage (62) before one or more ends of the wire cage (62) is or are closed and/or before one or more end caps (64) is or are affixed to the wire cage (62). The oyster shells (68) may extend across an entire length of the wire cage (62) or only a portion of the length.

Referring to FIGS. 8-9, the mounting wire (66) includes a fastener (67). The fastener (67) is a portion of the mounting wire (66) that is bent so that it can hang from a portion of a dock, such as a staple, a cleat, a nail, or the like. The fastener (67) may also be a portion of the mounting wire (66) that is tied into a knot, a loop, or the like, or it may be a component separate from the mounting wire (66), such as a hook, a strap, another wire, or the like.

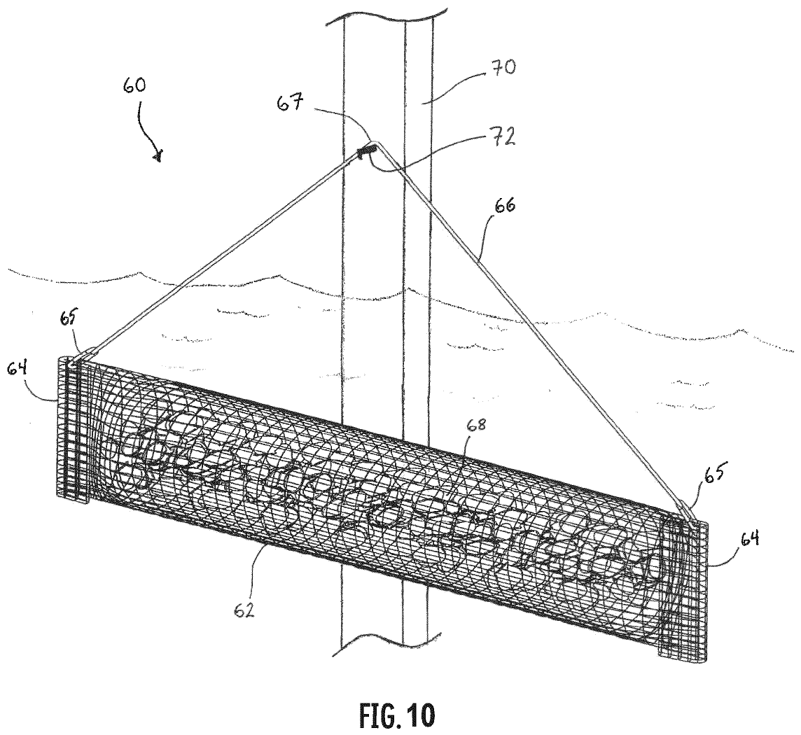

Referring to FIG. 10, the apparatus (60) is attached to a dock (70) via the fastener (67) of the mounting wire (66), which mates with a fastener (72) on the dock (70).

Those of ordinary skill in the art will appreciate that the present disclosure is not limited to any specific geometry or configuration and that the principles of the invention can be readily achieved via any of a wide variety of configurations, shapes, and sizes. Likewise, the present disclosure is not limited to the use of oyster shells, and the cages and pen can be filled with other types of mollusks or shells thereof.

Although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. An apparatus for use in forming oyster reefs, the apparatus comprising:
a wire cage having a cylindrical interior volume and a first open end with a first opening, the interior volume being filled with oyster shells; and
a first wire end cap covering the first opening.

2. The apparatus of claim 1, wherein the first open end tapers to a substantially planar edge.

3. The apparatus of claim 1, wherein:
the wire cage has a second open end with a second opening; and
a second wire end cap covers the second opening.

4. The apparatus of claim 1, further comprising a mounting wire with two ends;
wherein:
the wire cage has a second open end with a second opening;
a second wire end cap covers the second opening; and
the ends of the mounting wire are respectively attached to the first end cap and the second end cap.

5. The apparatus of claim 1, further comprising a mounting wire with two ends;
wherein:
the wire cage has a second open end; and
the ends of the mounting wire are respectively attached to the first open end and the second open end.

6. The apparatus of claim 1, further comprising:
a mounting wire attached to the wire cage;
wherein the mounting wire is configured to mate with a fastener on a dock.

7. The apparatus of claim 1, wherein the oyster shells are distributed across an entire length of the wire cage.

8. The apparatus of claim 1, wherein the interior volume is large enough to house five to ten gallons of non-living oysters.

9. The apparatus of claim 1, wherein, when the apparatus is submerged, oyster larvae attach to the oyster shells, with the oyster larvae being protected from marine life and ocean tides by the wire cage.

10. An apparatus for use in attracting and protecting oyster larvae and for forming oyster reefs, the apparatus adapted to be submerged in water with marine life and ocean tides, the apparatus comprising:
a wire cage with a first end, a second end, and a body therebetween;
the cylindrical body having a volume;
the wire cage being pinched at the first end and second end such that the first end and second end are substantially planar;
a first end cap on the first end;
a second end cap on the second end;
a strand of metal wire with a first strand end and a second strand end, the first strand end and second strand end being attached respectively to the first end and second end; and
oyster shells within the volume.

11. The apparatus of claim 10, wherein the first end cap is a rectangular piece of wire folded around the first end.

12. The apparatus of claim 10, wherein the wire cage continuously tapers between the body and the first end and between the body and the second end.

13. The apparatus of claim 10, wherein the strand of metal wire is configured to mate with a fastener on a dock.

14. The apparatus of claim 10, wherein the oyster shells are distributed across an entire length of the body.

15. The apparatus of claim 10, wherein the volume is large enough to house five to ten gallons of non-living oysters.

16. The apparatus of claim 10, wherein, when the apparatus is submerged, oyster larvae attach to the oyster shells, with the oyster larvae being protected from the marine life and ocean tides by the wire cage.

17. A system for attracting and protecting oyster larvae and for forming oyster reefs, the system comprising:
a wire cage with a first end, a second end, and a volume therebetween, the wire cage being pinched at the first end and second end such that the first end and second end are substantially planar;
oyster shells within the volume;
a mounting wire with a first wire end and a second wire end, the first wire end being attached to the first end of the wire cage and the second wire end being attached to the second end of the wire cage; and
a fastener configured to be attached to a fixed structure;
wherein the mounting wire mates with the fastener and attaches the wire cage to the fixed structure when the fastener is attached to the fixed structure.

18. The apparatus of claim 17, further comprising a first end cap attached to the first end of the wire cage.

19. The apparatus of claim 17, wherein the wire cage is cylindrical.

20. An apparatus for use in attracting and protecting oyster larvae and for forming oyster reefs, the apparatus adapted to be submerged in water with marine life and ocean tides, the apparatus comprising:
a wire cage with a first end, a second end, and a cylindrical body therebetween;
the cylindrical body having a volume;
the wire cage being pinched at the first end and second end such that the first end and second end are substantially planar;
the wire cage continuously tapering between the cylindrical body and the first end and between the cylindrical body and the second end;
a first end cap on the first end;
a second end cap on the second end;
the first end cap and second end cap being rectangular sections of wire cage folded respectively around the first end and second end; and
a strand of metal wire with a first strand end and a second strand end, the first strand end and second strand end being attached respectively to the first end and second end; and
oyster shells within the cylindrical volume.
